(19) United States
(12) Patent Application Publication
(10) Pub. No.: US 2024/0141942 A1
(43) Pub. Date: May 2, 2024

(54) PROJECTION-TYPE BLIND HYBRID FASTENING APPARATUS AND FASTENING METHOD THEREFOR

(71) Applicant: SUNG WOO HITECH CO., LTD., Busan (KR)

(72) Inventors: Seok Hwan HWANG, Busan (KR); Yun Sung CHUNG, Busan (KR); Sung Man SOHN, Yangsan-si (KR)

(21) Appl. No.: 18/088,001

(22) Filed: Dec. 23, 2022

(30) Foreign Application Priority Data
Nov. 2, 2022 (KR) 10-2022-0144114

(51) Int. Cl. F16B 19/10

(52) U.S. Cl. CPC F16B 19/1072

(57) ABSTRACT

In order to improve fastening precision, the present disclosure provides a projection-type blind hybrid fastening apparatus for fastening a first frame part which has an upper open side and through which a first coupling hole is formed and a second frame part through which a second coupling hole is formed, the apparatus including a projection fastening part including a head portion that extends outward from an upper rim surface of the first coupling hole and an extension support portion which extends upward from an inner end of the head portion and through which a first through-hole is formed on an inner circumference thereof, a blind fastening part which extends integrally upward from the extension support portion and through which a second through-hole communicating with the first through-hole is formed on an inner circumference thereof, and a tool coupling part which extends integrally upward from the blind fastening part and through which a third through-hole communicating with the second through-hole is formed on an inner circumference thereof.

### CROSS-REFERENCE TO RELATED APPLICATION

This application claims priority to and the benefit of Korean Patent Application No. 10-2022-0144114 filed on Nov. 2, 2022, the disclosure of which is incorporated herein by reference in its entirety.

### BACKGROUND

### 1. Field of the Invention

The present disclosure relates to a projection-type blind hybrid fastening apparatus, and more particularly, to a projection-type blind hybrid fastening apparatus having improved fastening precision.

### 2. Discussion of Related Art

In general, blind rivets are used in various applications including fastening thin plates to relatively thick components, and are used in various materials from steel to plastic.

Here, the blind rivets may be provided as permanent fastening elements for overlapping and fixing two or more plate materials or section steels. The blind rivets are widely used in vehicles, ships, bridges, and steel structures because the blind rivets have a simple structure, high applicability, and high capacity to transmit a force acting between members. Further, the blind rivets may be used for pressure containers or container boxes that require airtightness as the two plate materials are combined.

Further, in general, the blind rivets may include a rivet having a body portion extending from an inner end of a head portion and a stem portion provided to fasten the rivet to the plate material as an end portion of the body portion provided in the rivet inserted between the plate materials is deformed.

However, in the case of the blind rivet according to the related art, when the two or more plate materials are fastened while being spaced apart from each other, it is difficult to support the blind rivet to maintain a separation distance between the plate materials, and thus fastening strength is reduced.

Further, in the case of the blind rivet according to the related art, when the two or more plate materials are fastened while being spaced apart from each other, while the separation distance between the plate materials is narrowed or widened, the blind rivet is separated or spins.

### SUMMARY OF THE INVENTION

The present disclosure is directed to providing a projection-type blind hybrid fastening apparatus having improved fastening precision.

The present disclosure provides a projection-type blind hybrid fastening apparatus, for fastening a first frame part which has an upper open side and through which a first coupling hole is formed on one side of a bottom surface thereof and a second frame part which is formed in a hollow quadrangular cross section and through which a second coupling hole is formed on one side of a lower surface thereof, the apparatus including a projection fastening part including a head portion that extends radially outward in a circumferential direction so that a lower portion thereof is melted and bonded to an upper rim surface of the first coupling hole and an extension support portion which extends upward from an inner end of the head portion by a preset length corresponding to an interval between a bottom surface of the first frame part and a lower surface of the second frame part and through which the first through-hole is vertically formed on an inner circumference thereof, a blind fastening part that extends integrally upward from an inner end of the extension support portion such that a lower rim surface of the second coupling hole is seated thereon and has a wrinkle formed on an outer circumference thereof such that the wrinkle is plastically deformed during riveting and through which a second through-hole communicating with the first through-hole is vertically formed on an inner circumference thereof, and a tool coupling part that extends integrally upward from an upper end of the blind fastening part and is formed in a thickness exceeding the blind fastening part and through which a third through-hole communicating with the second through-hole is vertically formed on an inner circumference thereof and a fastening screw is formed on the inner circumference thereof.

The present disclosure also provides a projection-type blind hybrid fastening apparatus including a first frame part which has an upper open side and through which a first coupling hole is formed on one side of a bottom surface thereof, a second frame part which is formed in a hollow quadrangular cross section, through which a second coupling hole is formed on one side of a lower surface thereof, which has a bottom surface spaced a preset interval from a bottom surface of the first frame part, and which has both sides in close contact with an inner wall of the first frame part, a projection fastening part including a head portion that extends radially outward in a circumferential direction so that a lower portion thereof is melted and bonded to an upper rim surface of the first coupling hole and an extension support portion which extends upward from an inner end of the head portion by a preset length corresponding to an interval between a bottom surface of the first frame part and a lower surface of the second frame part and through which the first through-hole is vertically formed on an inner circumference thereof, a blind fastening part that extends integrally upward from an inner end of the extension support portion such that a lower rim surface of the second coupling hole is seated thereon and has an upper portion bent and riveted to an upper rim surface of the second coupling hole and through which a second through-hole communicating with the first through-hole is vertically formed on an inner circumference thereof, and a tool coupling part that extends integrally upward from an upper end of the blind fastening part and is formed in a thickness exceeding the blind fastening part and through which a third through-hole communicating with the second through-hole is vertically formed on an inner circumference thereof and a fastening screw is formed on the inner circumference thereof.

The present disclosure also provides a projection-type blind hybrid fastening method including a first operation of resistance-heating and then melting and bonding a lower portion of a head portion extending radially outward in a circumferential direction from an upper rim surface of a first coupling hole formed through one side of a bottom surface of a first frame part having an upper open side, a second operation of allowing both sides of a second frame part which is formed in a hollow quadrangular cross section and through which a second coupling hole is formed on one side of a lower surface thereof to be in close contact with an inner wall of the first frame part, allowing a lower rim surface of the second coupling hole to extend upward from an inner end of the head portion, allowing a first through-hole on an inner circumference thereof to be seated on a seating portion formed at an upper end of an extension support portion that is vertically penetrated, and allowing a blind fastening part extending upward from an inner end of the extension support portion to be inserted through the upper side of the second coupling hole, and a third operation of pulling downward a fastening tool in a state in which the fastening tool provided for rivet coupling is coupled to a fastening screw thread formed on an inner circumference of a tool coupling part connected to an upper portion of the blind fastening part, plastically deforming the blind fastening part, and thus riveting an upper rim surface of the second coupling hole.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1 and 2 are perspective views illustrating a projection-type blind hybrid fastening apparatus according to an embodiment of the present disclosure;

FIG. 3 is a cross-sectional view illustrating a usage state of the projection-type blind hybrid fastening apparatus according to the embodiment of the present disclosure;

FIGS. 4 to 8 are diagrams illustrating a fastening process of the projection-type blind hybrid fastening apparatus according to the embodiment of the present disclosure; and

FIG. 9 is a flowchart illustrating a projection-type blind hybrid fastening method according to the embodiment of the present disclosure.

### DETAILED DESCRIPTION OF EXEMPLARY EMBODIMENTS

Hereinafter, a projection-type blind hybrid fastening apparatus according to an embodiment of the present disclosure will be described in detail with reference to the accompanying drawings.

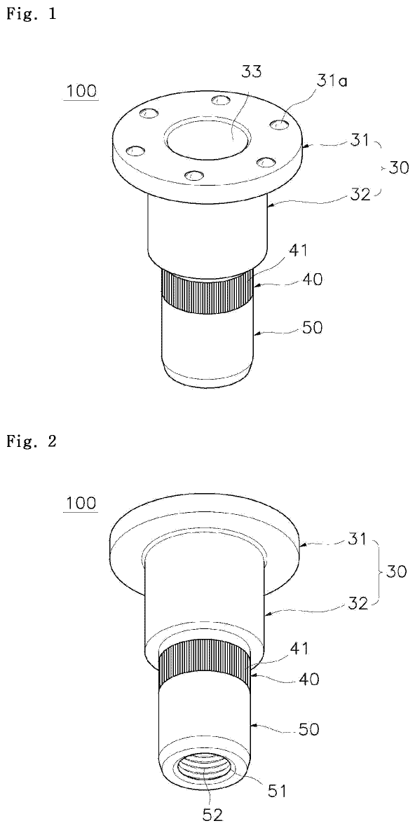

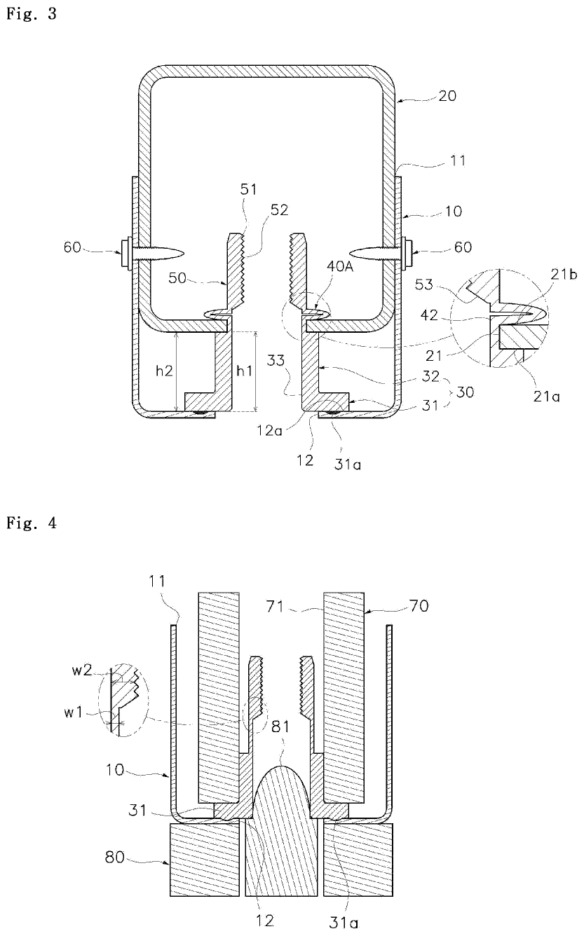

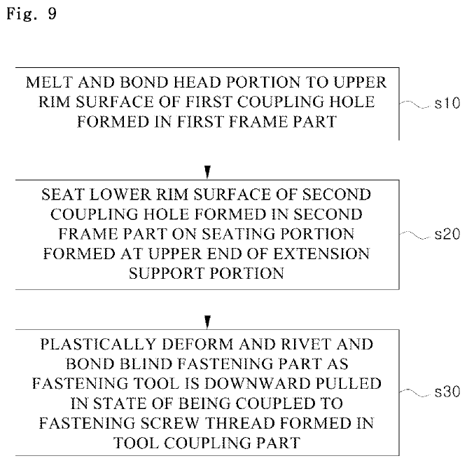

FIGS. 1 and 2 are perspective views illustrating a projection-type blind hybrid fastening apparatus according to an embodiment of the present disclosure, and FIG. 3 is a cross-sectional view illustrating a usage state of the projection-type blind hybrid fastening apparatus according to the embodiment of the present disclosure. Further, FIGS. 4 to 8 are diagrams illustrating a fastening process of the projection-type blind hybrid fastening apparatus according to the embodiment of the present disclosure. Further, FIG. 9 is a flowchart illustrating a projection-type blind hybrid fastening method according to the embodiment of the present disclosure.

As illustrated in FIGS. 1 to 9, a projection-type blind hybrid fastening apparatus 100 according to the embodiment of the present disclosure includes a projection fastening part 30, a blind fastening part 40, and a tool coupling part 50. Further, the projection-type blind hybrid fastening apparatus 100 according to the embodiment of the present disclosure may further include a first frame part 10 and a second frame part 20.

The projection-type blind hybrid fastening apparatus 100 is an apparatus for fastening the first frame part 10 and the second frame part 20.

Here, an upper side of the first frame part 10 may be open and a first coupling hole 12 may be formed through one side of a bottom surface of the first frame part 10. In this case, an opening 11 may be formed on the upper side of the first frame part 10 so that a lower portion of the second frame part 20 is inserted from the upper side to the lower side. That is, the first frame part 10 may be provided in a “U”-shaped cross-sectional shape with an open upper side. Further, the first frame part 10 may be made of a steel material, but the present disclosure is not limited thereto.

Further, the second frame part 20 may have a hollow quadrangular cross section and a second coupling hole 21 may be formed through one side of a bottom surface of the second frame part 20. That is, the second frame part 20 may be provided in a quadrangular-shaped cross-sectional shape. In this case, the first coupling hole 12 and the second coupling hole 21 may be formed at positions aligned with each other in a vertical direction. Further, the second frame part 20 may be extruded and provided with an aluminum material, but the present disclosure is not limited thereto.

Here, a lower surface of the second frame part 20 may be spaced a predetermined interval from the bottom surface of the first frame part 10, and both sides thereof may be in close contact with an inner wall of the first frame part 10.

Meanwhile, the projection fastening part 30, the blind fastening part 40, and the tool coupling part 50 may be formed integrally with each other and be made of a metal material. Further, the projection fastening part 30 includes a head portion 31 and an extension support portion 32.

Here, the head portion 31 may extend radially outward in a circumferential direction from a lower end of the projection fastening part 30 so that a lower portion of the head portion 31 is melted and bonded to an upper rim surface 12a of the first coupling hole 12. Further, an outer diameter of the head portion 31 may be set to exceed an inner diameter of the first coupling hole 12.

Further, projection protrusions 31a spaced apart from each other at regular intervals in the circumferential direction of the head portion 31 and protruding downward may be integrally formed on a lower surface of the head portion 31.

Further, each of the projection protrusion 31a is resistively heated through a resistance heating device (not illustrated) separately provided in a state of facing and being in contact with the upper rim surface 12a of the first coupling hole 12, and thus may be melted and bonded to the upper rim surface 12a of the first coupling hole 12.

In this case, the lower portion of the head portion 31 including the projection protrusion 31a and the lower surface of the head portion 31 may be melted and bonded to the upper rim surface 12a of the first coupling hole 12 in a projection welding manner.

Meanwhile, the extension support portion 32 may extend integrally upward to be bent from an inner end of the head portion 31 by a preset length h1 corresponding to an interval h2 between the bottom surface of the first frame part 10 and the lower surface of the second frame part 20. Further, an outer diameter of the extension support portion 32 may be set to exceed an inner diameter of the second coupling hole 21.

In this case, a seating portion 32a may be formed on a horizontal flat surface at an upper end of the extension support portion 32 such that a lower rim surface 21a of the second coupling hole 21 is seated on the upper end. Further, the seating portion 32a may be formed as a ring-shaped flat surface at the upper end of the extension support portion 32 in a circumferential direction of the extension support portion 32. In this case, the seating portion 32a may be stepped with an outer circumference of the blind fastening part 40.

Therefore, when the lower rim surface 21a of the second coupling hole 21 is seated on the seating portion 32a, the interval h2 between the bottom surface of the first frame part 10 and the lower surface of the second frame part 20 is maintained to correspond to the preset length h1 of the extension support portion 32.

Further, a first through-hole 33 may be vertically formed through an inner circumference of the extension support portion 32.

Meanwhile, the blind fastening part 40 may extend integrally upward from an inner end of the extension support portion 32 to be stepped with the seating portion 32a formed at an upper end of the extension support portion 32 such that the lower rim surface 21a of the second coupling hole 21 is seated thereon. In this case, an outer diameter of the blind fastening part 40 may be set to correspond to the inner diameter of the second coupling hole 21.

Further, a wrinkle part 41 may be formed on the outer circumference of the blind fastening part 40 in a circumferential direction. For example, in the wrinkle part 41, a wrinkle groove extending vertically from the outer circumference of the blind fastening part 40 may be recessed radially inward. In this case, a plurality of wrinkle grooves may be spaced apart from each other in the circumferential direction of the blind fastening part 40 at regular intervals. Of course, in some cases, the wrinkle part 41 may also be formed on an inner circumference of the blind fastening part 40 in the circumferential direction.

Here, the blind fastening part 40 is plastically deformed by a fastening tool 90, which will be described below, and may be riveted to the upper rim surface 21b of the second coupling hole 21. That is, the blind fastening part 40 extending in a straight line in the vertical direction may be plastically deformed into a blind fastening part 40A bent and deformed in a concave shape radially outward.

Further, a second through-hole 42 communicating with the first through-hole 33 may be vertically formed through the inner circumference of the blind fastening part 40. In this case, an inner diameter of the first through-hole 33 may be the same as an inner diameter of the second through-hole 42. Accordingly, inner circumferences of the first through-hole 33 and the second through-hole 42 may be formed in a continuous outline.

Meanwhile, the tool coupling part 50 may integrally extend upward from an upper end of the blind fastening part 40 and may be formed in a thickness exceeding the blind fastening part 40.

Here, a third through-hole 51 communicating with the second through-hole 42 may be vertically formed through an inner circumference of the tool coupling part 50. Further, a fastening screw thread 52 may be formed on an inner circumference of the third through-hole 51. In this case, an inner diameter of the third through-hole 51 may be set to be less than the inner diameters of the first through-hole 33 and the second through-hole 42. That is, an inner diameter of the tool coupling part 50 may be set to be less than an inner diameter of the blind fastening part 40. Further, an outer diameter of the tool coupling part 50 may be set to correspond to the outer diameter of the blind fastening part 40. Further, a radial thickness w1 of the blind fastening part 40 may be set to be less than a radial thickness w2 of the tool coupling part 50.

Further, a guide slope surface 53 may be formed at a lower end of the tool coupling part 50 such that the guide slope surface 53 is inclined upward in a radially inward direction in a circumferential direction toward the upper side. Therefore, since the fastening tool 90 is guided by the guide slope surface 53 and is easily fastened to the fastening screw thread 52, fastening convenience can be significantly improved.

Meanwhile, a projection-type blind hybrid fastening method according to an embodiment of the present disclosure will be described with reference to FIGS. 4 to 9.

Here, the projection-type blind hybrid fastening method according to the embodiment of the present disclosure includes operation s10 of melting and bonding a head portion to an upper rim surface of a first coupling hole formed in a first frame part. Further, the projection-type blind hybrid fastening method according to the embodiment of the present disclosure includes operation s20 of seating a lower rim surface of a second coupling hole formed in a second frame part on a seating portion formed at an upper end of an extension support portion. Further, the projection-type blind hybrid fastening method according to the embodiment of the present disclosure includes operation S30 of plastically deforming and riveting a blind fastening part as a fastening tool is pulled downward while being coupled to a fastening screw thread formed in a tool coupling part.

In detail, the lower portion of the head portion 31 is resistance-heated and melted and bonded to the upper rim surface of the first coupling hole 12 formed through the one side of the bottom surface of the first frame part 10 having an upper open side (s10).

Here, referring to FIG. 4, the lower portion of the head portion 31 including the projection protrusion 31a and the lower surface of the head portion 31 may be melted and bonded to the upper rim surface 12a of the first coupling hole 12 in a projection welding manner.

Further, a first die 70 may be inserted from the opening 11 formed on an open upper side of the first frame part 10. In this case, a lower surface of the first die 70 may be pressed in surface contact with an outer upper rim surface of the head portion 31.

Here, an insertion hole 71 may be formed vertically through a central portion of the first die 70 and an inner diameter of the insertion hole 71 may be set to be greater than or equal to the outer diameter of the extension support portion 32 and be less than the outer diameter of the head portion 31. In this case, the inner diameter of the insertion hole 71 may be set to correspond to the outer diameter of the extension support portion 32.

Accordingly, when the lower surface of the first die 70 is pressed in surface contact with the outer upper rim surface of the head portion 31, the extension support portion 32, the blind fastening part 40, and the tool coupling part 50 may be inserted into the insertion hole 71.

Further, the lower surface of the first frame part 10 may be in surface contact with an outer upper surface of a second die 80 on which the lower surface of the first frame part 10 is seated. At the same time, a protrusion die 81 protruding upward from a central portion of the second die 80 may be inserted into the first through-hole 33.

Here, the outer upper surface of the second die 80 may be formed as a flat surface parallel to the lower surface of the first frame part 10, and the protrusion die 81 may protrude upward from an upper surface of a central portion of the second die 80. In this case, the protrusion die 81 may protrude in an upwardly convex rounded shape, and one side of the inner circumference of the first through-hole 33 may be fitted to one side of an outer circumference of the protrusion die 81.

Therefore, when the lower surface of the first die 70 is pressed in surface contact with the outer upper rim surface of the head portion 31, the second die 80 may support the first frame part 10. At the same time, the protrusion die 81 may be fixedly fitted in one side of the inner circumference of the first through-hole 33, and thus the head portion 31 may fixed. Accordingly, the lower portion of the head portion 31 may be melted and bonded to the upper rim surface 12a of the first coupling hole 12 without mutual lifting by the pressing of the first die 70 and the second die 80.

Meanwhile, the lower rim surface of the second coupling hole 21 formed in the second frame part 20 is seated on the seating portion 32a formed at an upper end of the extension support portion 32 (s20).

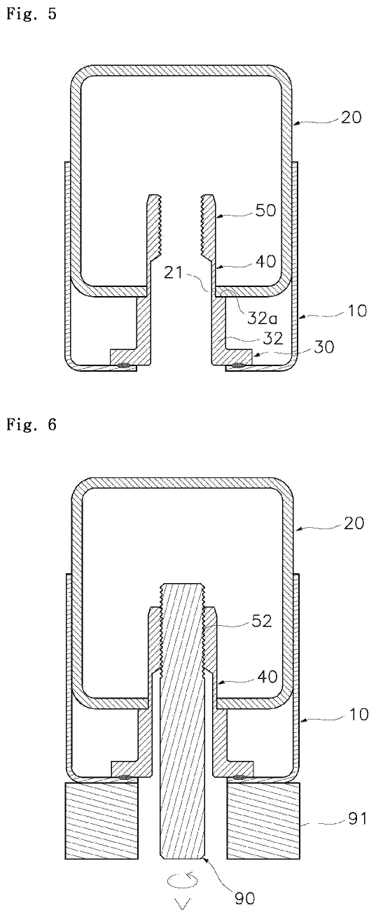

In detail, referring to FIG. 5, both sides of the second frame part 20 which is formed in a hollow quadrangular cross section and through which the second coupling hole 21 is formed on one side thereof may be in close contact with the inner wall of the first frame part 10. At the same time, the lower rim surface 21a of the second coupling hole 21 may be seated on the seating portion 32a formed at the upper end of the extension support portion 32 extending upward from the inner end of the head portion 31.

In addition, the blind fastening part 40 and the tool coupling part 50 extending upward from the inner end of the extension support portion 32 may be inserted through an upper side of the second coupling hole 21 and may be arranged inside the second frame part 20.

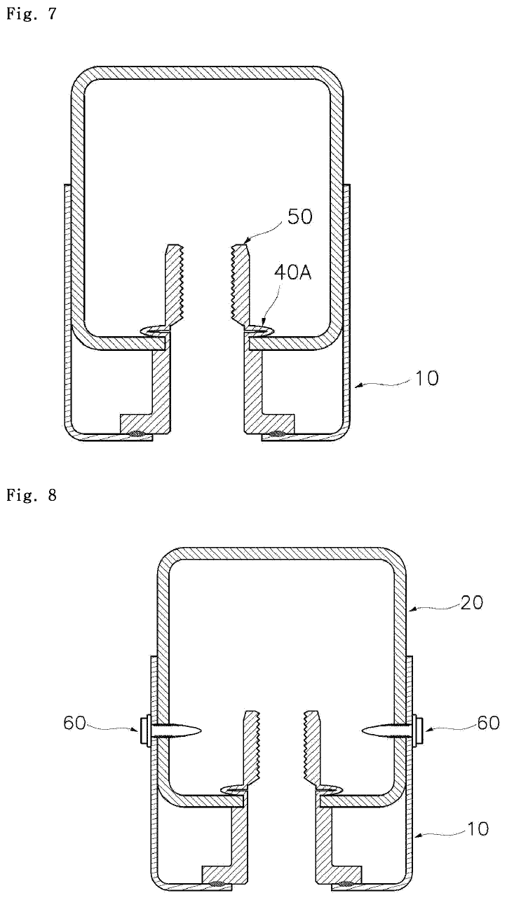

Meanwhile, referring to FIGS. 6 and 7, as the fastening tool 90 provided for rivet coupling is pulled downward while being coupled to the fastening screw thread 52 formed at the tool coupling part 50, the blind fastening part 40 is plastically deformed and rivet-coupled (s30).

Here, the fastening tool 90 may be provided to have an outer diameter corresponding to the inner diameter of the third through-hole 51 and may extend vertically, and a screw thread corresponding to the fastening screw thread 52 may be formed on an upper outer circumference. Further, the fastening tool 90 may be connected to a traction device (not illustrated) separately provided at a lower portion thereof and may be pulled downward by an external force of the traction device (not illustrated). Accordingly, as the fastening tool 90 is pulled downward, the blind fastening part 30 may be plastically deformed and riveted to the upper rim surface 21b of the second coupling hole 21.

Next, referring to FIG. 8, an operation of fastening at least one fastening device 60 to the inner wall of the first frame part 10 and both sides of the second frame part 20 which are in close contact with each other may be further performed. In this case, the fastening device 60 may be provided as a screw having a length exceeding a sum of the thicknesses of the inner wall of the first frame part 10 and both sides of the second frame part 20. Therefore, the fastening device 60 may be fastened through the inner wall of the first frame part 10 and both sides of the second frame part 20 which are in close contact with each other, and thus the first frame part and the second frame part 20 can be stably fixed.

In this way, according to the present disclosure, the extension support portion 32 may extend upward from the inner end of the head portion 31 by a preset length corresponding to an interval between the bottom surface of the first frame part and the lower surface of the second frame part 20 spaced apart from each other for shock absorption. In this case, the bottom surface of the first frame part 10 and the lower surface of the second frame part 20 may be spaced apart from each other to provide shock absorption when used for purposes such as vehicle dampers or battery cases.

Thus, in a state in which the first frame part 10 is melted and bonded to the head portion 31 and the second frame part 20 is seated on the seating portion 32a, when the riveting is performed by the blind fastening part 40, a stable support force by the extension support portion 32 can be provided.

Further, the tool coupling part 50 having the fastening screw thread 52 formed on an inner circumference thereof may extend upward from an upper end of the blind fastening part 40 extending upward from the extension support portion 32. In this case, since the tool coupling part 50 is formed to have a thickness exceeding the blind fastening part 40, when the blind fastening part 40 is plastically deformed by the fastening tool 90, the blind fastening part 40 can be stably guided and riveted to the upper rim surface 21b of the second coupling hole 21. Accordingly, fastening precision between the blind fastening part 40 and the upper rim surface 21b of the second coupling hole 21 can be remarkably improved.

The present disclosure provides the following effects according to the embodiment described above.

First, since an extension support portion extends upward from an inner end of a head portion by a length corresponding to an interval between a first frame part and a second frame part spaced apart from each other for shock absorption, when rivet coupling is performed by the blind fastening part in a state in which the first frame part is melted and bonded to the head portion, and the second frame part is seated on the seated portion a stable support force can be provided by the extension support portion.

Second, a tool coupling part having a fastening screw thread formed on an inner circumference thereof extends upward from an upper end of the blind fastening part extending from the extension support portion, the tool coupling part is formed in a thickness exceeding the blind fastening part, and thus when the blind fastening part is plastically deformed by a fastening tool, the blind fastening part is stably guided to an upper rim surface of a second coupling hole and riveted, so that fastening precision can be improved.

Third, as a guide slope surface inclined upward inward radially in a circumferential direction toward the upper side is formed at a lower end of the tool coupling part, the fastening tool provided for rivet coupling is guided by the guide slope surface and is easily fastened to the fastening screw thread on an inner circumference of the tool coupling part, so that fastening convenience can be remarkably improved.

In this case, terms such as “includes”, “constitutes”, or “has” described above mean that the corresponding component may be inherent unless otherwise stated, and thus should be construed as not excluding other components but further including other components. All terms including technical or scientific terms have the same meanings as those commonly understood by those skilled in the art to which the present disclosure pertain unless otherwise defined. The generally used terms defined in the dictionaries should be construed as having the meanings that coincide with the meanings of the contexts of the related technologies and should not be construed as ideal or excessively formal meanings unless clearly defined in the present disclosure.

As described above, the present disclosure is not limited to the above-described respective embodiments, modifications could be made by those skilled in the art to which the present disclosure pertains without departing from the range of the present disclosure claimed by the appended claims, and the modifications belong to the scope of the present disclosure.

What is claimed is:

1. A projection-type blind hybrid fastening apparatus for fastening a first frame part which has an upper open side and through which a first coupling hole is formed on one side of a bottom surface thereof and a second frame part which is formed in a hollow quadrangular cross section and through which a second coupling hole is formed on one side of a lower surface thereof, the apparatus comprising:
a projection fastening part including a head portion that extends radially outward in a circumferential direction so that a lower portion thereof is melted and bonded to an upper rim surface of the first coupling hole and an extension support portion which extends upward from an inner end of the head portion by a preset length corresponding to an interval between a bottom surface of the first frame part and a lower surface of the second frame part and through which the first through-hole is vertically formed on an inner circumference thereof;
a blind fastening part that extends integrally upward from an inner end of the extension support portion such that a lower rim surface of the second coupling hole is seated thereon and has a wrinkle formed on an outer circumference thereof such that the wrinkle is plastically deformed during riveting and through which a second through-hole communicating with the first through-hole is vertically formed on an inner circumference thereof; and
a tool coupling part that extends integrally upward from an upper end of the blind fastening part and is formed in a thickness exceeding the blind fastening part and through which a third through-hole communicating with the second through-hole is vertically formed on an inner circumference thereof and a fastening screw is formed on the inner circumference thereof.

2. The projection-type blind hybrid fastening apparatus of claim 1, wherein a seating portion is formed at an upper end of the extension support portion to be stepped with the outer circumference of the blind fastening part, and
the blind fastening part extends integrally upward from an inner end of the extension support portion to be stepped with the seating portion.

3. The projection-type blind hybrid fastening apparatus of claim 2, wherein the seating portion is formed at the upper end of the extension support portion in the circumferential direction,
an outer diameter of the extension support portion is set to exceed an inner diameter of the second coupling hole,
an outer diameter of the blind fastening part is set to correspond to the inner diameter of the second coupling hole, and
an outer diameter of the head portion is set to exceed an inner diameter of the first coupling hole.

4. The projection-type blind hybrid fastening apparatus of claim 1, wherein projection protrusions spaced apart from each other at regular intervals in the circumferential direction and protruding downward are integrally formed on a lower surface of the head portion.

5. The projection-type blind hybrid fastening apparatus of claim 1, wherein an outer diameter of the tool coupling part is set to correspond to an outer diameter of the blind fastening part, and
an inner diameter of the tool coupling part is set to be less than an inner diameter of the blind fastening part.

6. The projection-type blind hybrid fastening apparatus of claim 1, wherein a guide slope surface that is inclined upward inward radially in the circumferential direction toward the upper side is formed at a lower end of the tool coupling part.

7. A projection-type blind hybrid fastening apparatus comprising:
a first frame part which has an upper open side and through which a first coupling hole is formed on one side of a bottom surface thereof;
a second frame part which is formed in a hollow quadrangular cross section, through which a second coupling hole is formed on one side of a lower surface thereof, which has a bottom surface spaced a preset interval from a bottom surface of the first frame part, and which has both sides in close contact with an inner wall of the first frame part;
a projection fastening part including a head portion that extends radially outward in a circumferential direction so that a lower portion thereof is melted and bonded to an upper rim surface of the first coupling hole and an extension support portion which extends upward from an inner end of the head portion by a preset length corresponding to an interval between a bottom surface of the first frame part and a lower surface of the second frame part and through which the first through-hole is vertically formed on an inner circumference thereof;
a blind fastening part that extends integrally upward from an inner end of the extension support portion such that a lower rim surface of the second coupling hole is seated thereon and has an upper portion bent and riveted to an upper rim surface of the second coupling hole and through which a second through-hole communicating with the first through-hole is vertically formed on an inner circumference thereof; and
a tool coupling part that extends integrally upward from an upper end of the blind fastening part and is formed in a thickness exceeding the blind fastening part and through which a third through-hole communicating with the second through-hole is vertically formed on an inner circumference thereof and a fastening screw is formed on the inner circumference thereof.

8. The projection-type blind hybrid fastening apparatus of claim 7, wherein a seating portion is formed at an upper end of the extension support portion to be stepped with an outer circumference of the blind fastening part, and
the blind fastening part extends integrally upward from an inner end of the extension support portion to be stepped with the seating portion.

9. The projection-type blind hybrid fastening apparatus of claim 7, wherein an outer diameter of the tool coupling part is set to correspond to an outer diameter of the blind fastening part,
an inner diameter of the tool coupling part is set to be less than an inner diameter of the blind fastening part, and
a guide slope surface that is inclined upward inward radially in the circumferential direction toward the upper side is formed at a lower end of the tool coupling part.

10. The projection-type blind hybrid fastening apparatus of claim 7, wherein the seating portion is formed at the upper end of the extension support portion in the circumferential direction,
an outer diameter of the extension support portion is set to exceed an inner diameter of the second coupling hole, and
an outer diameter of the blind fastening part is set to correspond to the inner diameter of the second coupling hole.

11. A projection-type blind hybrid fastening method comprising:
a first operation of resistance-heating and then melting and bonding a lower portion of a head portion extending radially outward in a circumferential direction from an upper rim surface of a first coupling hole formed through one side of a bottom surface of a first frame part having an upper open side;
a second operation of allowing both sides of a second frame part which is formed in a hollow quadrangular cross section and through which a second coupling hole is formed on one side of a lower surface thereof to be in close contact with an inner wall of the first frame part, allowing a lower rim surface of the second coupling hole to extend upward from an inner end of the head portion, allowing a first through-hole on an inner circumference thereof to be seated on a seating portion formed at an upper end of an extension support portion that is vertically penetrated, and allowing a blind fastening part extending upward from an inner end of the extension support portion to be inserted through the upper side of the second coupling hole; and
a third operation of pulling downward a fastening tool in a state in which the fastening tool provided for rivet coupling is coupled to a fastening screw thread formed on an inner circumference of a tool coupling part connected to an upper portion of the blind fastening part, plastically deforming the blind fastening part, and thus riveting an upper rim surface of the second coupling hole.
